(19) United States
(12) Patent Application Publication
(10) Pub. No.: US 2011/0001889 A1
(43) Pub. Date: Jan. 6, 2011

(54) PERSONAL COMPUTER

(75) Inventors: CHUN-LIN HUANG, Shindian (TW); TZU-CHENG YU, Santa Clara, CA (US)

Correspondence Address: Altis Law Group, Inc.;ATTN: Steven Reiss, 288 SOUTH MAYO AVENUE, CITY OF INDUSTRY, CA, 91789, US

(73) Assignee: FIH (HONG KONG) LIMITED, Kowloon (HK)

(21) Appl. No.: 12/771,184

(22) Filed: Apr. 30, 2010

(30) Foreign Application Priority Data
Jul. 6, 2009 (CN) 200910304031.5

(51) Int. Cl. H04N 9/31

(52) U.S. Cl. 348/744; 348/E09.025

(57) ABSTRACT

A personal computer (PC) includes a main body, a processor received in the main body, and a projecting unit received in the main body and electrically connected to the processor. The PC does not include a built-in display. The processor transmits image signals to the projecting unit, the projecting unit projects images onto a nearby projection surface corresponding to received image signals, so that the nearby projection surface serves as a display of the PC.

### BACKGROUND

1. Technical Field

The present disclosure relates to personal computers (PC), and particularly to a PC with a built-in projector.

2. Description of Related Art

Projectors are often connected to personal computers (PC) to project images displayed by the computers onto a projection surface that is more convenient to observe and whereby the image may be enlarged. Conventional projectors are generally difficult to carry due to their large size and weight. Furthermore, when the projectors are frequently used, it is inconvenient to connect and disconnect the projectors to and from PC frequently. Therefore, miniaturized built-in projectors are becoming popular. The built-in projectors are integrated with a PC, and thus they can be easily carried and can eliminate the connection and disconnection operations.

However, when a built-in projector projects images from a PC, the same images continue to be displayed by a conventional display of the PC, which is unnecessary and may consume much electric power.

Therefore, there is room for improvement within the art.

### BRIEF DESCRIPTION OF THE DRAWINGS

Many aspects of the present PC can be better understood with reference to the following drawings. The components in the various drawings are not necessarily drawn to scale, the emphasis instead being placed upon clearly illustrating the principles of the present PC. Moreover, in the drawings, like reference numerals designate corresponding parts throughout the figures.

FIG. 1 is a block diagram of a PC, according to a first exemplary embodiment.

FIG. 2 is a schematic view of the PC shown in FIG. 1.

FIG. 3 is a schematic view of a PC, according to a second exemplary embodiment.

### DETAILED DESCRIPTION

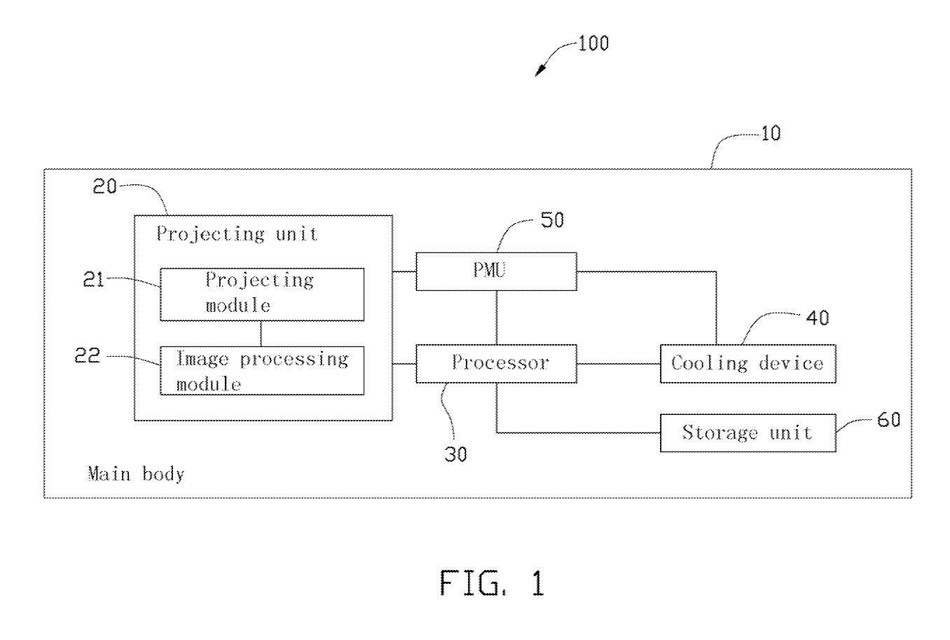

FIG. 1 schematically shows a notebook PC 100, according to a first exemplary embodiment. The PC 100 includes a main body 10, a projecting unit 20, a processor 30, a cooling device 40, a power management unit (PMU) 50, and a storage unit 60. The PC 100 does not include a display in this embodiment. Instead, a suitable projection surface in the vicinity of the PC 100 will act as a display of the PC 100. The projecting unit 20, the processor 30, the cooling device 40, the power management unit (PMU) 50, and the storage unit 60 are all received in the main body 10. The projecting unit 20, the cooling device 40, the PMU 50, and the storage unit 60 are all electrically connected to the processor 30. The PMU 50 is also electrically connected to the projecting unit 20 and the cooling device 40.

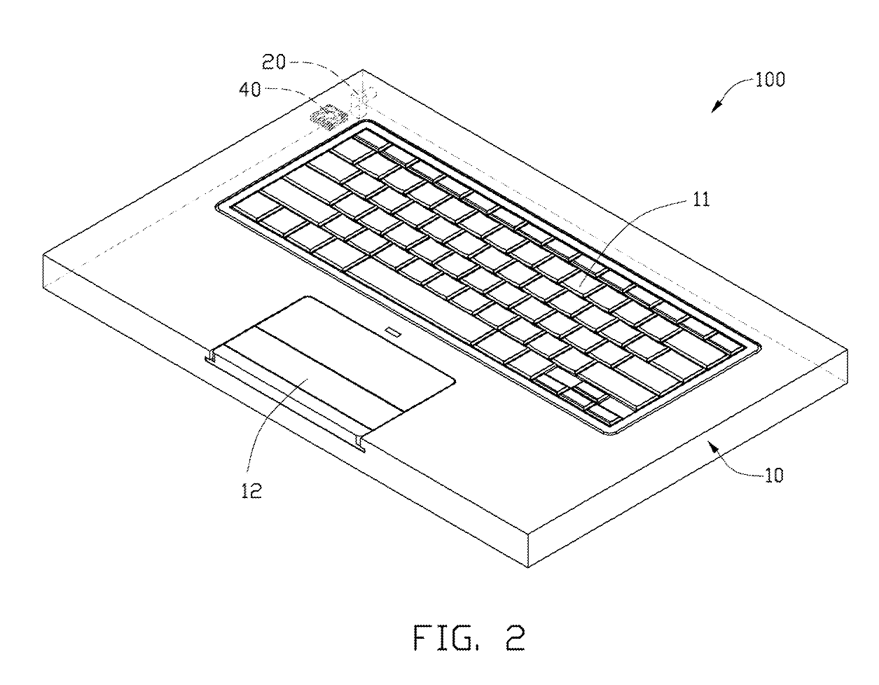

Also referring to FIG. 2, the main body 10 can be a housing of the PC 100. The main body 10 includes a keypad 11 and a touch control area 12 formed thereon.

The projecting unit 20 can be a built-in projector, which is positioned adjacent to a corner of the main body 10. The projecting unit 20 includes a projecting module 21 and an image processing module 22 electrically connected to the projecting module 21. The projecting module 21 includes conventional optical mechanisms and projecting circuits. In use, image signals can be transmitted to the image processing module 22. The image processing module 22 decodes the signals and transmits the decoded signals to the projecting module 21. The projecting module 21 projects images according to the decoded signals.

The processor 30 can be the central processing unit (CPU) of the PC 100. The processor 30 can transmit image signals to the image processing module 22 and can also control the PMU 50 to supply electric power to the projecting unit 20 and the cooling device 40. The cooling device 40 can be a fan positioned adjacent to the projecting unit 20 and controlled by the processor 30. The storage unit 60 can be a conventional storage unit of the PC 100.

When the PC 100 is used, the storage unit 60 temporarily stores data of the images to be projected by the projecting unit 20. The processor 30 controls the PMU 50 to supply electric power to the projecting unit 20. Thus, the processor 30 reads image data from the storage unit 60 and transmits signals corresponding to the read image data to the image processing module 22. The image processing module 22 decodes the signals and transmits the decoded signals to the projecting module 21. The projecting module 21 projects images onto a projection surface such as a nearby wall or screen according to the decoded signals. The projected images are what you would normally see on a display of a computer when operated. Therefore, any suitable nearby projection surface on which images can be projected can serve as a display, and the PC 100 can be normally used though it has no conventional display. The processor 30 can also control the PMU 50 to supply electric power to the cooling device 40 and control the cooling device 40 to function, thereby cooling the projecting unit 20.

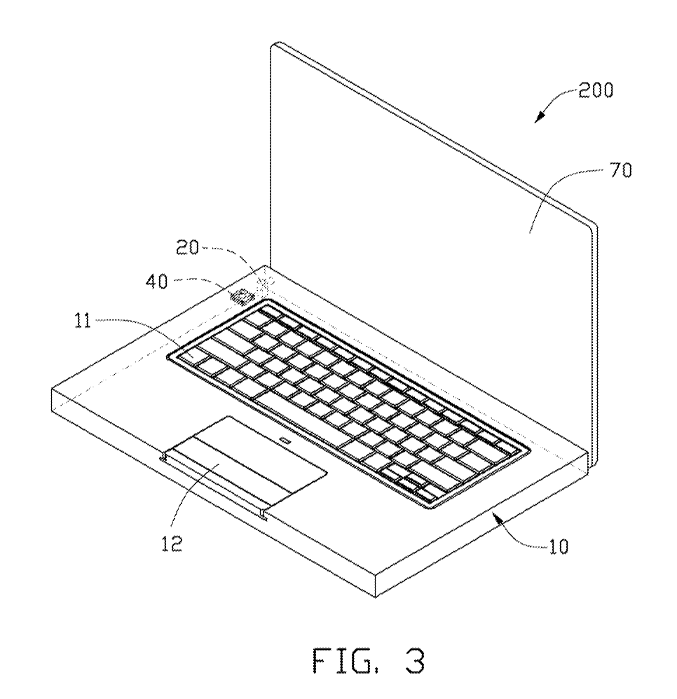

FIG. 3 schematically shows a PC 200, according to a second exemplary embodiment. The PC 200 is similar to the PC 100, except that the PC 200 further includes a cover 70 slidably mounted on the main body 10 to protect the keypad 11 and the touch control area 12.

In the present disclosure, rather than have a heavy and fragile display included in the PC 100/200, any of a variety of projection surfaces can serve as a display of the PC 100/200, thereby saving energy and money.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A personal computer (PC), comprising:
a main body;
a processor received in the main body; and
a projecting unit received in the main body and electrically connected to the processor; wherein the processor transmits image signals to the projecting unit, the projecting unit projects images corresponding to received image signals onto a projection surface not an integral part of the PC, and the projection surface serves as a display of the PC.

2. The PC as claimed in claim 1, wherein the projecting unit includes a projecting module and an image processing module electrically connected to the projecting module, the processor transmitting image signals to the image processing module, the image processing module decoding the signals and transmitting the decoded signals to the projecting module, and the projecting module projecting images according to the decoded signals.

3. The PC as claimed in claim 1, wherein the main body includes a keypad and a touch control area formed thereon.

4. The PC as claimed in claim 1, further comprising a storage unit received in the main body and electrically connected to the processor, the storage unit storing data of images to be projected by the projecting unit.

5. The PC as claimed in claim 1, further comprising a cooling device received in the main body and positioned adjacent to the projecting unit for cooling the projecting unit.

6. The PC as claimed in claim 1, further comprising a cover rotatably mounted on the main body.
